(19) United States
(12) Patent Application Publication
(10) Pub. No.: US 2008/0188204 A1
(43) Pub. Date: Aug. 7, 2008

(54) SYSTEM AND METHOD FOR PROCESSING A VOICEMAIL MESSAGE

(76) Inventor: Anders Gavner, Danderyd (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/672,057

(22) Filed: Feb. 7, 2007

(51) Int. Cl. H04M 11/10; H04M 1/00

(52) U.S. Cl. 455/413; 455/550.1

(57) ABSTRACT

A method of processing a voicemail message includes examining the voicemail message for the presence of spoken number values and converting identified spoken numbers to alphanumeric characters. In one embodiment, the examining includes analyzing the identified spoken numbers to identify a series of spoken numbers, the series of spoken numbers used as a representation of a telephone number spoken by a caller that left the voicemail message.

### TECHNICAL FIELD OF THE INVENTION

The present invention relates generally to voice messaging systems and, more particularly, to a system and method for processing a voicemail message.

### DESCRIPTION OF THE RELATED ART

Voice messaging systems, also known as voicemail systems, provide a convenient way for a caller to record a voice message for a called party if the called party does not answer the caller's call. The recorded message may be retrieved by the called party at a later time for audible playback.

In most mobile telephone environments and in most corporate phone systems, voice messaging is hosted by a central server that records the message. To retrieve a recorded message, the recipient of the message may access the central server. Similar services are available to residential “land-line” telephone users and voice over internet protocol (VoIP) users. In addition to server-based implementations, user-maintained recording devices referred to as “answering machines” may be used by connecting the answer machine to a telephone jack.

It is often customary that a caller include his or her telephone number as part of a recorded voicemail message. Frequently, the telephone number is a spoken series of numbers. Unfortunately, many people have difficulty remembering such a series of numbers. Also, a person listening to a voice message may not have immediate access to a writing implement and/or a writing surface to write down the number for future reference. This may occur most often with mobile telephone users, but may occur with other types of telephone users. If the user cannot memorize the telephone number from the recorded message and/or does not may a written record of the telephone number, it may be difficult to return the call. In addition, even if the user is capable of memorizing the telephone number for immediate use in returning the call, the user may forget all or part of the number for use in the future.

### SUMMARY

To improve access to a telephone number that is recorded as part of a voice message, there is a need in the art for a system and method for processing the voice message. The processing may identify the telephone number, convert the telephone number to alphanumeric text characters and present the user with one or more options for using the telephone number, such as dialing the number, storing the number, editing the number and so forth.

According to one aspect of the invention, a method of processing a voicemail message includes examining the voicemail message for the presence of spoken number values; and converting identified spoken numbers to alphanumeric characters.

According to one embodiment of the method, the examining includes analyzing the identified spoken numbers to identify a series of spoken numbers, the series of spoken numbers used as a representation of a telephone number spoken by a caller that left the voicemail message.

According to one embodiment, the method further includes offering at least one option for using the representation of the telephone number to a user of an electronic device.

According to one embodiment of the method, the at least one option includes dialing the telephone.

According to one embodiment of the method, the at least one option includes storing the telephone number.

According to one embodiment of the method, the option to store the telephone number includes populating a field of a contact list entry with the telephone number.

According to one embodiment of the method, the at least one option includes editing the telephone number.

According to one embodiment of the method, the examining and converting are carried out by a server that hosts a voicemail message service for a user of a calling device.

According to one embodiment of the method, the examining and converting are carried out after retrieval of the voicemail message and in response to a user command.

According to one embodiment of the method, the examining and converting are carried out automatically during or before retrieval of the voicemail message.

According to another aspect of the invention, an electronic device includes call circuitry for establishing a call over a communications network; and a controller that processes a voicemail message by examining the voicemail message for the presence of spoken number values and converting identified spoken numbers to alphanumeric characters.

According to one embodiment of the electronic device, the examining includes analyzing the identified spoken numbers to identify a series of spoken numbers, the series of spoken numbers used as a representation of a telephone number spoken by a caller that left the voicemail message.

According to one embodiment of the electronic device, the controller is configured to offer an option for using the representation of the telephone number to a user of an electronic device, the option including at least one of dialing the telephone, storing the telephone number, populating a field of a contact list entry with the telephone number or editing the telephone number.

According to one embodiment of the electronic device, the electronic device is a mobile telephone.

According to another aspect of the invention, a server hosts a voicemail message service and the server includes a processor that executes logic to process a voicemail message by examining the voicemail message for the presence of spoken number values and converting identified spoken numbers to alphanumeric characters.

According to one embodiment of the server, the examining includes analyzing the identified spoken numbers to identify a series of spoken numbers, the series of spoken numbers used as a representation of a telephone number spoken by a caller that left the voicemail message.

According to another aspect of the invention, a program for processing a voicemail message is embodied on a machine readable medium. The program includes executable logic to examine the voicemail message for the presence of spoken number values; and convert identified spoken numbers to alphanumeric characters.

According to one embodiment of the program, the logic to examine includes logic to analyze the identified spoken numbers to identify a series of spoken numbers, the series of spoken numbers used as a representation of a telephone number spoken by a caller that left the voicemail message.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device in accordance with an embodiment of the present invention;

FIG. 2 is a schematic block diagram of the relevant portions of the mobile telephone of FIG. 1 in accordance with an embodiment of the present invention;

FIG. 3 is a schematic diagram of a communications system in which the mobile telephone of FIG. 1 may operate;

FIG. 4 is a flow chart representing an exemplary embodiment of a method of processing a voicemail message in accordance with an embodiment of the present invention; and

FIG. 5 is a flow chart representing another exemplary embodiment of a method of processing a voicemail message in accordance with an embodiment of the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of a mobile telephone and a voicemail system hosted by a server. However, it will be appreciated that the invention is not intended to be limited to the context of a mobile telephone and may relate to any type of appropriate electronic equipment, and the invention is not intended to be limited to the context of server-hosted voice message recording system.

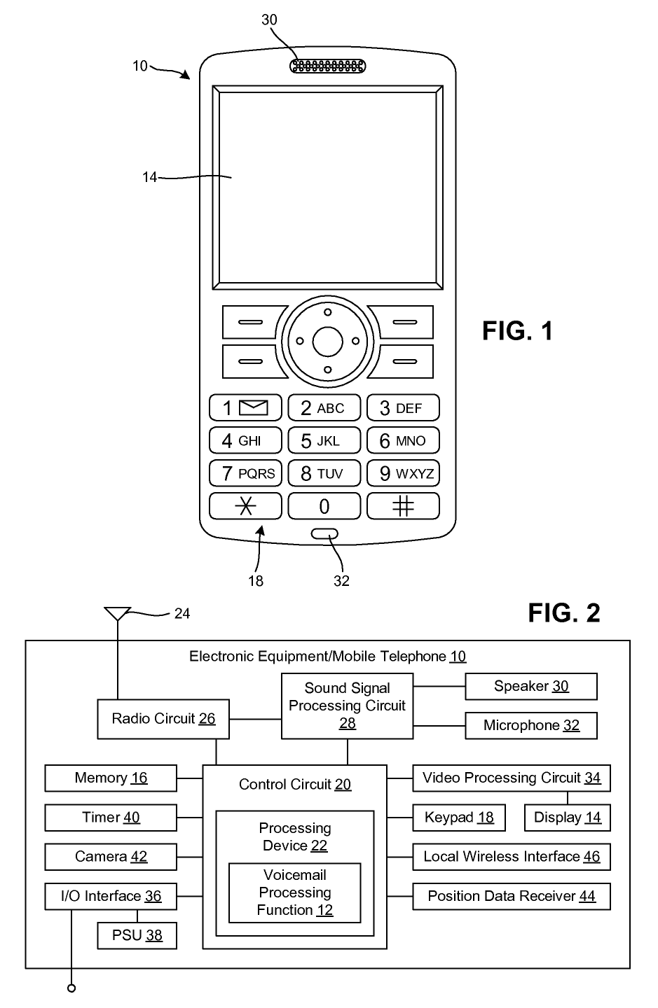

Referring initially to FIGS. 1 and 2, an electronic device 10 is shown. The electronic device 10 may include a voicemail processing function 12 that is configured to identify a telephone number from a voicemail message. It will be appreciated that, in other embodiments, the voicemail processing function 12 may be hosted by another device (e.g., a remote server). Exemplary alternative implementations will be described below. Also, additional details and operation of the voicemail processing function 12 will be described in greater detail below. The voicemail processing function 12 may be embodied as executable code that is resident in and executed by the electronic device 10. In one embodiment, the voicemail processing function 12 may be a program stored on a computer or machine readable medium. The voicemail processing function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other type housings, such as a “flip-open” form factor (e.g., a clamshell housing) or a slide-type housing, may be utilized.

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 16. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi, WiMax, etc. Another example includes a video enabled call that is established over a cellular or alternative network.

The mobile telephone 10 may be configured to transmit, receive and/or process data, such as text messages (e.g., colloquially referred to by some as “an SMS,” which stands for simple message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 2 represents a functional block diagram of the mobile telephone 10. For the sake of brevity, generally conventional features of the mobile telephone 10 will not be described in great detail herein. The mobile telephone 10 includes a primary control circuit 20 that is configured to carry out overall control of the functions and operations of the mobile telephone 10. The control circuit 20 may include a processing device 22, such as a CPU, microcontroller or microprocessor. The processing device 22 executes code stored in a memory (not shown) within the control circuit 20 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory or other suitable device.

In addition, the processing device 22 may execute code that implements the voicemail processing function 12. It will be apparent to a person having ordinary skill in the art of computer programming, and specifically in application programming for mobile telephones or other electronic devices, how to program a mobile telephone 10 to operate and carry out logical functions associated with the voicemail processing function 12. Accordingly, details as to specific programming code have been left out for the sake of brevity. Also, while the voicemail processing function 12 is executed by the processing device 22 in accordance with a preferred embodiment of the invention, such functionality could also be carried out via dedicated hardware, firmware, software, or combinations thereof, without departing from the scope of the invention.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24 as is conventional. The radio circuit 26 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, MBMS, WiFi, WiMax, DVB-H, ISDB-T, etc., as well as advanced versions of these standards.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10 as is conventional. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors and so forth. The video data may be generated by the control circuit 20, retrieved from a video file that is stored in the memory 16, derived from an incoming video data stream received by the radio circuit 28 or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter.

The mobile telephone 10 also may include a timer 40 for carrying out timing functions. Such functions may include timing the durations of calls, generating the content of time and date stamps, etc. The mobile telephone 10 may include a camera 42 for taking digital pictures and/or movies. Image and/or video files corresponding to the pictures and/or movies may be stored in the memory 16. The mobile telephone 10 also may include a position data receiver 44, such as a global positioning system (GPS) receiver, Galileo satellite system receiver or the like.

The mobile telephone 10 also may include a local wireless interface 46, such as an infrared transceiver and/or an RF adaptor (e.g., a Bluetooth interface), for establishing communication with an accessory, another mobile radio terminal, a computer or another device. For example, the local wireless interface 46 may operatively couple the mobile telephone 10 to a headset assembly (e.g., a PHF device) in an embodiment where the headset assembly has a corresponding wireless interface.

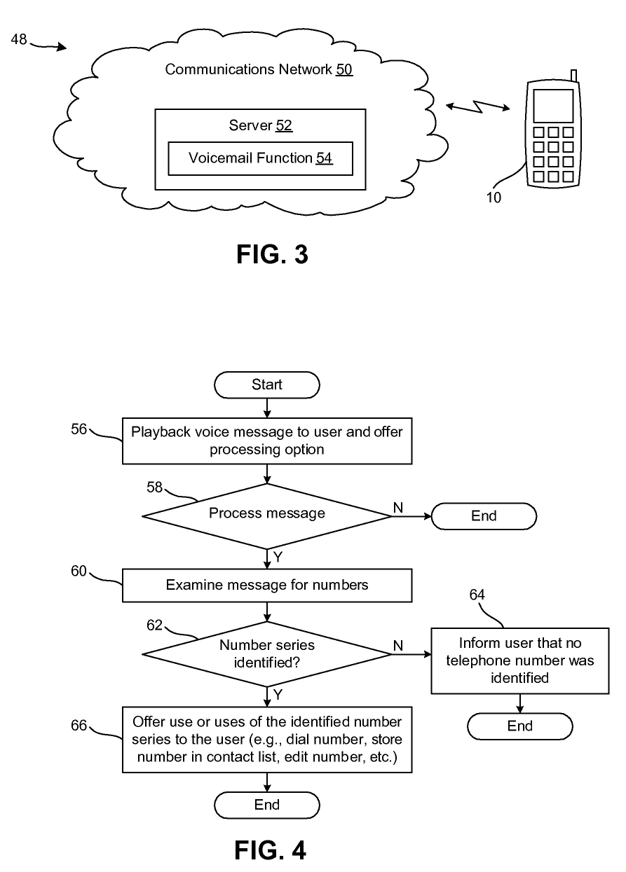

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10 and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices.

As will be appreciated, the server 52 may be configured as a typical computer system used to carry out server functions and may include a processor configured to execute software containing logical instructions that embody the functions of the server 52 and a memory to store such software. In one embodiment, the server 52 may be configured to store and execute a voicemail function 54. Details of the voicemail function 54 will be described below in greater detail. In one embodiment, the voicemail function 54 may be a program stored on a computer or machine readable medium. The voicemail function 54 may be a stand-alone software application or may form a part of a software application that carries out additional tasks related to the functions of the server 54. In one embodiment, the functions of the voicemail function 54 may be distributed among multiple servers, including one or more servers located outside the domain of the communications network 50.

In the illustrated embodiment, the voicemail function may be responsible for managing voicemail messages for the mobile telephones 10 serviced by the communications network 50. For instance, if a call destined to the mobile telephone 10 is not answered by the user of the mobile telephone 10, the call may be transferred to the server 52 to prompt the caller to leave a message for the user. If the caller leaves a message, the message may be recorded by the voicemail function 54 for subsequent retrieval by the user of the mobile telephone 10. Since the server 52 may typically have a greater amount of processing capacity than the mobile telephone 10, it is contemplated that the processing to identify a telephone number from a recorded voice message may be carried out by the server 52. The mobile telephone 10 may interface with the server 52 in a client/server relationship where user input and commands are received by the server 52 from the mobile telephone 10 to control the voicemail function 54 and data may be sent from the server 52 to mobile telephone 10 for additional processing and/or presentation to the user. However, other embodiments and other system architectures may allow for a greater amount of the processing to be carried out by the client-side device, such as by execution of an embodiment of the voicemail processing function 12. Thus, it will be appreciated that the voicemail processing function 12 may interact with the voicemail function 54 so that the functions 12, 54 together carry out the logical operations described herein or just one of the functions 12, 54 is used to carry out the logical operations described herein.

With additional reference to FIG. 4, illustrated are logical operations to implement an exemplary method of processing a voice message. The exemplary method may be carried out by executing an embodiment of the voicemail processing function 12 and/or the voicemail function 54, for example. Thus, the flow chart of FIG. 4 may be thought of as depicting steps of a method carried out by the mobile telephone 10, the server 52, or partially by the mobile telephone 10 and partially by the server 52. In yet other embodiments, the method may be carried out in whole or in part by an answering machine, a plain old telephone system (POTS) telephone, a VoIP-enable telephone or VoIP-enabled computing device, a telephone server that manages calls for a corporate telephone system, a server that manages voicemail messages for POTS telephones and/or VoIP-enabled devices, the mobile telephone 10, the server 54, and/or any other device that is configured to carry out the functionality of the method.

Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the voicemail processing function 12 and/or the voicemail function 54 may begin in block 56. For purposes of the description of the logical operations of the voicemail processing function 12 and/or the voicemail function 54, it will be assumed that a voice message has been left by caller and the message is stored in a manner that is accessible by the voicemail processing function 12 and/or the voicemail function 54. If the voicemail message processing is to be carried out by the mobile telephone 10 and the voicemail message is stored by the server 52, the mobile telephone 10 may capture and store the audio content of the voicemail message during voicemail message playback or an audio file associated with the voicemail message may be transferred to the mobile telephone 10 for processing.

In block 56, the voicemail message may be played back to the user in the ordinary manner that a voice message is played back to the user. Further, the user may be presented with an option to process the voicemail message to attempt to identify a telephone number that is part of the spoken voicemail message. In one embodiment, the user may be presented with menu options as part of a graphical user interface. In another embodiment, the voicemail function 54 may provide the user with audible menu choices that may be selected by depressing corresponding keys of the keypad 18. Exemplary audible menu choices may include “press one to save the message” and “press two delete the message.” Other menu choices may be to repeat the message, forward the message, and so on. As indicated, one menu option may be to attempt to extract a telephone number from the message. As used herein, the phrase “extract a telephone number from a message” may include attempting to convert a telephone number spoken by the caller who left the message into a text-based version of the telephone.

In block 58, a determination may be as to whether the user selected a menu option to process the message to attempt to convert a telephone number spoken by the caller who left the message into a text-based version of the telephone. If a negative determination is made, the logical flow of processing the voicemail message may end or may proceed to another voicemail message function, such as deleting or saving the voicemail message.

If a positive determination is made in block 58, the logical flow may proceed to block 60. In block 60, the voicemail message may be examined for the presence of one or more numbers. In one embodiment, a speech-to-text converter (e.g., a software-based speech recognition engine) may be used to analyze the voice message for the presence of spoken numerical values and to output corresponding numbers, such as in the form of alphanumeric characters. Since telephone numbers are typically recited as a series of numerical values, the processing may be carried out to identify numerical values spoken in a sequence. Such a list of numerical values that are spoken with correspondence to one another by the caller who left the voicemail message may be assumed to be a telephone number. It will be appreciated that additional processing may be carried out to identify telephone numbers from recorded message content, including processing to distinguish a telephone number or telephone numbers from other speech components of the recorded message.

Proceeding to block 62, a determination may be made as to whether the voicemail message examination of block 60 resulted in the identification of series of numerical values that has the potential to be a telephone number. If a negative determination is made in block 62, the logical flow may proceed to block 64 where the user may be informed that the analysis of the voicemail message failed to detect a telephone number, such as by displaying a message to the user or audibly outputting a message to the user. Following block 64, the logical flow of processing the voicemail message may end or may proceed to another voicemail message function, such as deleting or saving the voicemail message.

If a positive determination is made in block 62, the logical flow may proceed to block 66. In block 66, the identified series of numbers may be displayed to the user. Also, one or more options for using the identified series of numbers may be offered to the user. For instance, the identified series of numbers may be dialed to call the telephone number recited by the caller in the voicemail message that was examined in block 60. Another option may be to store the identified series of numbers. For instance, the identified series of numbers may be stored as part of a contact list entry and/or the identified series of numbers may be stored in a temporary file or log for future use by the user to dial the number or to populate a field in a contact list entry. Another option may be to edit the number. For instance, if the identified series of numbers does not match the user's recollection of the numbers, the user may change the identified series. Following block 66, the logical flow of processing the voicemail message may end or may proceed to another voicemail message function, such as deleting or saving the voicemail message.

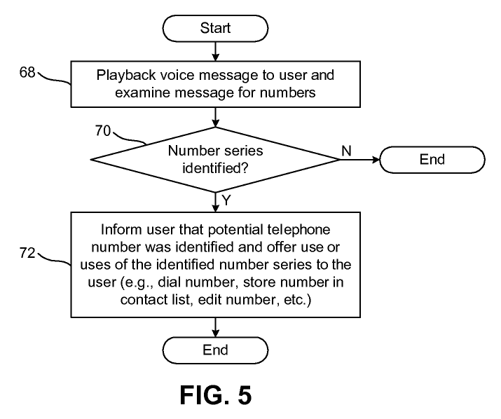

In the embodiment illustrated by FIG. 4, the user listens to the recorded voicemail message and then is presented with an option to analyze the voicemail message for a telephone number. With additional reference to FIG. 5, another exemplary method of processing a voicemail message is illustrated. In the embodiment of FIG. 5, the voicemail message is automatically examined for the presence of a telephone number. Similar to the embodiment of FIG. 4, FIG. 5 illustrates logical operations to implement an exemplary method of processing a voice message. The exemplary method may be carried out by executing an embodiment of the voicemail processing function 12 and/or the voicemail function 54, for example. Thus, the flow chart of FIG. 5 may be thought of as depicting steps of a method carried out by the mobile telephone 10, the server 52, or partially by the mobile telephone 10 and partially by the server 52. In yet other embodiments, the method may be carried out in whole or in part by an answering machine, a POTS telephone, a VoIP-enable telephone or VoIP-enabled computing device, a telephone server that manages calls for a corporate telephone system, a server that manages voicemail messages for POTS telephones and/or VoIP-enabled devices, the mobile telephone 10, the server 54, and/or any other device that is configured to carry out the functionality of the method.

Although FIG. 5 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the embodiment of the voicemail processing function 12 and/or the voicemail function 54 illustrated in FIG. 5 may begin in block 68. For purposes of the description of the logical operations of the voicemail processing function 12 and/or the voicemail function 54, it will be assumed that a voice message has been left by caller and the message is stored in a manner that is accessible by the voicemail processing function 12 and/or the voicemail function 54.

In block 68, the voicemail message may be played back to the user in the ordinary manner that a voice message is played back to the user. Further, the voicemail message may be examined for the presence of one or more numbers. In one embodiment, a speech-to-text converter (e.g., a software-based speech recognition engine) may be used to analyze the voice message for the presence of spoken numerical values and to output corresponding numbers, such as in the form of alphanumeric characters. Since telephone numbers are typically recited as a series of numerical values, the processing may be carried out to identify numerical values spoken in a sequence. Such a list of numerical values that are spoken with correspondence to one another by the caller who left the voicemail message may be assumed to be a telephone number. It will be appreciated that additional processing may be carried out to identify telephone numbers from recorded message content, including processing to distinguish a telephone number or telephone numbers from other speech components of the recorded message.

Proceeding to block 70, a determination may be made as to whether the voicemail message examination of block 68 resulted in the identification of series of numerical values that has the potential to be a telephone number. If a negative determination is made in block 70, the logical flow of processing the voicemail message may end or may proceed to another voicemail message function, such as deleting or saving the voicemail message.

If a positive determination is made in block 70, the logical flow may proceed to block 72. In block 72, the user may be informed that a potential telephone number was identified. The user may be informed by displaying a notice, which may include displaying the identified series of numbers, and/or by generating an audible output. Also, one or more options for using the identified series of numbers may be offered to the user. For instance, the identified series of numbers may be dialed to call the telephone number recited by the caller in the voicemail message that was examined in block 68. Another option may be to store the identified series of numbers. For instance, the identified series of numbers may be stored as part of a contact list entry and/or the identified series of numbers may be stored in a temporary file or log for future use by the user to dial the number or to populate a field in a contact list entry. Another option may be to edit the number. For instance, if the identified series of numbers does not match the user's recollection of the numbers, the user may change the identified series. Following block 72, the logical flow of processing the voicemail message may end or may proceed to another voicemail message function, such as deleting or saving the voicemail message.

In still other embodiments, the examination of the voicemail message for the presence of a telephone number may be carried out as the caller leaves the voicemail message or after the voicemail message has been recorded, but before the voicemail message is retrieved by the user.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of processing a voicemail message, comprising:
examining the voicemail message for the presence of spoken number values; and
converting identified spoken numbers to alphanumeric characters.

2. The method of claim 1, wherein the examining includes analyzing the identified spoken numbers to identify a series of spoken numbers, the series of spoken numbers used as a representation of a telephone number spoken by a caller that left the voicemail message.

3. The method of claim 2, further comprising offering at least one option for using the representation of the telephone number to a user of an electronic device.

4. The method of claim 3, wherein the at least one option includes dialing the telephone.

5. The method of claim 3, wherein the at least one option includes storing the telephone number.

6. The method of claim 5, wherein the option to store the telephone number includes populating a field of a contact list entry with the telephone number.

7. The method of claim 3, wherein the at least one option includes editing the telephone number.

8. The method of claim 2, wherein the examining and converting are carried out by a server that hosts a voicemail message service for a user of a calling device.

9. The method of claim 2, wherein the examining and converting are carried out after retrieval of the voicemail message and in response to a user command.

10. The method of claim 2, wherein the examining and converting are carried out automatically during or before retrieval of the voicemail message.

11. An electronic device, comprising:
call circuitry for establishing a call over a communications network; and
a controller that processes a voicemail message by examining the voicemail message for the presence of spoken number values and converting identified spoken numbers to alphanumeric characters.

12. The electronic device of claim 11, wherein the examining includes analyzing the identified spoken numbers to identify a series of spoken numbers, the series of spoken numbers used as a representation of a telephone number spoken by a caller that left the voicemail message.

13. The electronic device of claim 12, wherein the controller is configured to offer an option for using the representation of the telephone number to a user of an electronic device, the option including at least one of dialing the telephone, storing the telephone number, populating a field of a contact list entry with the telephone number or editing the telephone number.

14. The electronic device of claim 11, wherein the electronic device is a mobile telephone.

15. A server that hosts a voicemail message service, comprising a processor that executes logic to process a voicemail message by examining the voicemail message for the presence of spoken number values and converting identified spoken numbers to alphanumeric characters.

16. The server of claim 15, wherein the examining includes analyzing the identified spoken numbers to identify a series of spoken numbers, the series of spoken numbers used as a representation of a telephone number spoken by a caller that left the voicemail message.

17. A program for processing a voicemail message that is embodied on a machine readable medium, the program comprising executable logic to:
examine the voicemail message for the presence of spoken number values; and
convert identified spoken numbers to alphanumeric characters.

18. The program of claim 17, wherein the logic to examine includes logic to analyze the identified spoken numbers to identify a series of spoken numbers, the series of spoken numbers used as a representation of a telephone number spoken by a caller that left the voicemail message.
